(19) United States
(12) Patent Application Publication
(10) Pub. No.: US 2011/0148419 A1
(43) Pub. Date: Jun. 23, 2011

(54) APPARATUS AND METHOD FOR DETECTING UNDERGROUND OBJECTS

(75) Inventors: Kwang-Yun CHO, Daejeon (KR); Je-Hoon Yun, Daejeon (KR)

(73) Assignee: ELECTRONICS AND TELECOMMUNICATIONS RESEARCH INSTITUTE, Daejeon (KR)

(21) Appl. No.: 12/853,770

(22) Filed: Aug. 10, 2010

(30) Foreign Application Priority Data
Dec. 21, 2009 (KR) 10-2009-0128526

(51) Int. Cl. G01V 3/08

(52) U.S. Cl. 324/329

(57) ABSTRACT

A wearable apparatus for detecting an underground object includes: a signal transmitter configured to transmit a predetermined signal in a predetermined direction; a reception detection sensor configured to receive a reflected wave corresponding to the transmitted signal; a wireless reception unit configured to restore the received reflected wave to a received signal; and an acknowledgement signal processing unit configured to analyze whether the underground object exists or not, based on the restored received signal, and generate first and second acknowledgement signals depending on whether the underground object exists or not.

### CROSS-REFERENCE(S) TO RELATED APPLICATIONS

The present application claims priority of Korean Patent Application No. 10-2009-0128526, filed on Dec. 21, 2009, which is incorporated herein by reference in its entirety.

### BACKGROUND OF THE INVENTION

1. Field of the Invention

Exemplary embodiments of the present invention relate to an apparatus and method for detecting underground objects; and, more particularly, to a wearable apparatus for detecting underground objects and a method for detecting underground objects.

2. Description of Related Art

Conventionally, power has been transferred through telegraph poles and electric cables on the ground. Furthermore, all power transfer lines have been constructed on the ground. Currently, however, power transfer lines are being laid underground due to the spatial limitations and beauties of cities. To manage such utilities laid underground, the positions of the utilities should be accurately identified. Therefore, it is not easy to manage the utilities. Furthermore, there is a limitation in figuring out the position of a dangerous article laid underground.

Accordingly, an underground object detector is used to find an object laid underground. Such an underground object detector is frequently utilized for finding the positions of utilities such as gas pipes and power cables.

However, the conventional underground object detector requires separate equipment which is passively controlled. The weight of the equipment may reduce the efficiency of the underground object detector, and the underground object detector has a delay time for receiving and processing reflected waves. Therefore, there is demand for an apparatus which is capable of transmitting/receiving signals in real time and is easy to carry while finding an underground object.

### SUMMARY OF THE INVENTION

An embodiment of the present invention is directed to a wearable apparatus for detecting underground objects and a method for detecting underground objects

Another embodiment of the present invention is directed to a wearable apparatus for detecting underground objects capable of receiving information in real time and a method for detecting underground objects.

Another embodiment of the present invention is directed to a wearable apparatus for detecting underground objects which is easy to implement and a method for detecting underground objects.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a wearable apparatus for detecting an underground object includes: a signal transmitter configured to transmit a predetermined signal in a predetermined direction; a reception detection sensor configured to receive a reflected wave corresponding to the transmitted signal; a wireless reception unit configured to restore the received reflected wave to a received signal; and an acknowledgement signal processing unit configured to analyze whether the underground object exists or not, based on the restored received signal, and generate first and second acknowledgement signals depending on whether the underground object exists or not.

In accordance with another embodiment of the present invention, a method for detecting an underground object includes: transmitting a predetermined signal in a predetermined direction; when a reflected wave corresponding to the transmitted signal is a predetermined reflected wave, analyzing the predetermined reflected wave; and generating a first acknowledgement signal corresponding to the analyzed reflected wave, and informing a user of the first acknowledgement signal.

### BRIEF DESCRIPTION OF THE DRAWINGS

FIG. 1 is a configuration diagram of a wearable apparatus for detecting underground objects in accordance with an embodiment of the present invention.

FIG. 2 is a flow chart explaining a method for detecting underground objects in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

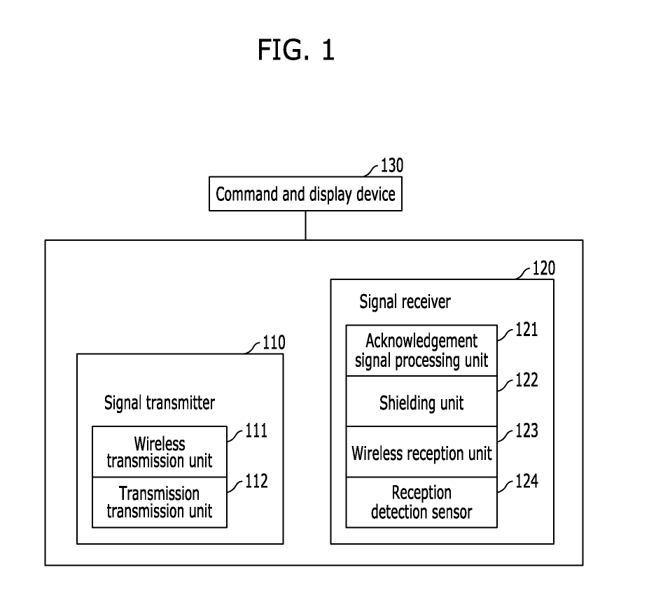

FIG. 1 is a configuration diagram of a wearable apparatus for detecting underground objects in accordance with an embodiment of the present invention.

Referring to FIG. 1, the wearable apparatus for detecting underground objects includes a signal transmitter 110, a signal receiver 120, and a command and display device 130. The signal transmitter 110 is configured to transmit a signal to detect an underground object. The signal receiver 120 is configured to receive a signal corresponding to the transmitted signal. The command and display device 130 is configured to command the transmission of the signal for detecting the underground object or display the underground object information analyzed from the received signal. The signal transmitter 110 includes a wireless transmission unit 111 and a transmission detection sensor 112. The wireless transmission unit 111 is configured to generate a signal to be wirelessly transmitted, and the transmission detection sensor 112 is configured to transmit the signal generated by the wireless transmission unit 111. The signal receiver 120 includes a reception detection sensor 124, a wireless reception unit 123, a shielding unit 122, and an acknowledgement signal processing unit 121. The reception detection sensor 124 is configured to receive a reflected signal corresponding to the signal transmitted from the signal transmitter 110. The wireless reception unit 123 is configured to restore the signal received by the reception detection sensor 124 into a reflected wave corresponding to the transmitted signal. The shielding unit 122 is configured to shield electromagnetic waves transmitted to a user. The acknowledgement signal processing unit 121 is configured to detect whether an underground object exists or not, based on a predetermined standard, by using the reflected wave restored by the wireless reception unit 123, and generate the detection information.

Referring to FIG. 1, the operation of the wearable apparatus for detecting underground objects in accordance with the embodiment of the present invention will be described in detail. The wearable apparatus for detecting underground objects in accordance with embodiment of the present invention is mounted on a specific portion of an article which may be worn by a user, without using a separate device for detecting underground objects. The wireless transmission unit 111 of the signal transmitter 110 generates a signal used for detecting an underground object and transfers the generated signal to the transmission detection sensor 112. The transmission detection sensor 112 transmits the signal generated by the wireless transmission unit 111 in a predetermined direction. The above-described signal and reflected wave may include electromagnetic wave energy or ultrasonic wave energy. The reception detection sensor 124 of the signal receiver 120 receives a reflected wave corresponding to the signal transmitted from the transmission detection sensor 112 and transfers the received reflected wave to the wireless reception unit 123. The wireless reception unit 123 restores the reflected wave transferred from the reception detection sensor 124 into a received signal corresponding to the signal generated by the wireless transmission unit 111, and transfers the restored signal to the acknowledgement signal processing unit 121. The acknowledgement signal processing unit 121 analyzes the received signal restored by the wireless reception unit 123, generates an acknowledgement signal including detection information on whether the underground object exists or not, and transfers the acknowledgement signal to the command and display device 130. The acknowledgement signal processing unit 121 generates a target acknowledgement signal when the underground object exists, and generates a noise acknowledgement signal when the underground object does not exist. When the underground object exists, a specific reflected wave different from a reflected wave which is normally received is received depending on the material property of the underground object. The acknowledgement signal processing unit 121 analyzes the specific reflected wave and generates the acknowledgement signal such that a user may figure out the material property of the underground object through the analysis result. The shielding unit 122 is a device for shielding electromagnet waves transmitted to a user. The shielding unit 122 may be implemented between the wireless transmission unit 111 and the transmission detection sensor 112. Furthermore, a plurality of shielding units 122 or a single shielding unit may be implemented in the wireless reception unit 123 and the acknowledgement signal processing unit 121. Furthermore, the shielding unit 122 may be implemented in a portion in which shielding is required.

The wearable apparatus for detecting underground objects in accordance with the embodiment of the present invention may be mounted on shoes, for example, in order to utilize the space diversity of signals. In this case, the signal transmitter 110 transmitting a signal and the signal receiver 120 receiving a reflected wave corresponding to the transmitted signal may be mounted on the lowest portions of the right and left shoes, respectively. In order to detect underground objects, in this case, the user simply wears shoes, e.g., the work shoes or the military shoes, equipped with the wearable apparatus for detecting underground object, instead of attaching a separate detection apparatus on the body. The above-described wearable apparatus for detecting underground objects may be configured in various shapes including a horizontal structure as well as the vertical structure of FIG. 1.

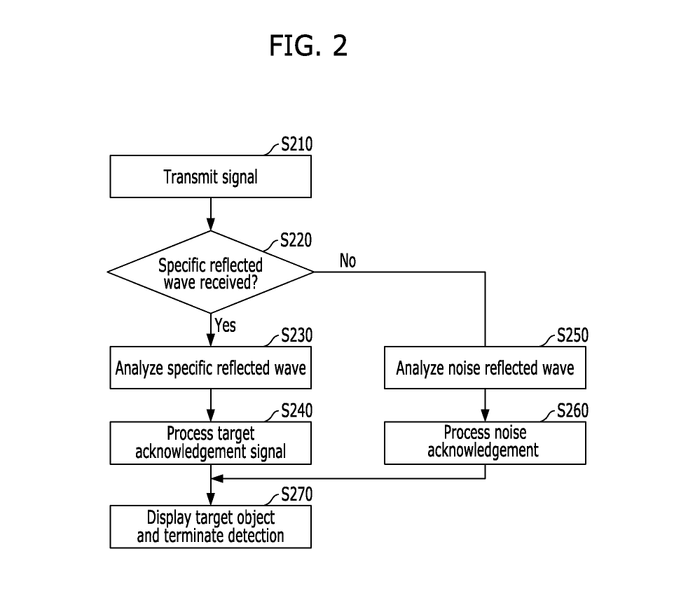

FIG. 2 is a flow chart explaining a method for detecting underground objects in accordance with another embodiment of the present invention.

In a step S210, the signal transmitter 110 transmits a signal for detecting an underground object. In a step S220, the reception detection sensor 124 receives a reflected wave corresponding to the signal transmitted, the wireless reception unit 123 restores the received wave into a received signal corresponding to the signal transmitted from the signal transmitter 110, and the acknowledgement signal processing unit 121 determines whether the received wave is a specific reflected wave or not. When it is determined in the step S220 that the received wave is a specific reflected wave, that is, when the underground object exists, the acknowledgement signal processing unit 121 analyzes the specific reflected wave in a step S230. Then, the acknowledgement signal processing unit 121 generates a target acknowledgement signal based on the specific reflected wave and transfers the detection information to the command and display device 130 in a step S240. Then, the detection operation is completed in a step S270.

When it is determined in the step S220 that the reflected wave restored by the wireless reception unit 123 is not the specific reflected wave, that is, when the underground object does not exist, the acknowledgement signal processing unit 121 analyzes the reflected wave which is normally received, that is, a noise reflected wave in a step S250. Then, the acknowledgement signal processing unit 121 generates a noise acknowledgement signal, and transfers the noise acknowledgement signal to the command and display device 130. Then, the detection operation is completed in the step S270.

The wearable apparatus for detecting underground objects in accordance with the embodiment of the present invention may be installed in an article which may be worn by a user, such as shoes, and may detect underground objects such as gas pipes and communication and power cables in real time, without using a separate device. Since the wearable apparatus for detecting underground objects in accordance with the embodiment of the present invention detects the positions of the underground objects such as gas pipes and communication and power cables in real time, it may prevent safety accidents in construction sites and increase operation efficiency.

While the present invention has been described with respect to the specific embodiments, it will be apparent to those skilled in the art that various changes and modifications may be made without departing from the spirit and scope of the invention as defined in the following claims.

What is claimed is:

1. A wearable apparatus for detecting an underground object, comprising:
a signal transmitter configured to transmit a predetermined signal in a predetermined direction;
a reception detection sensor configured to receive a reflected wave corresponding to the transmitted signal;
a wireless reception unit configured to restore the received reflected wave to a received signal; and
an acknowledgement signal processing unit configured to analyze whether the underground object exists or not, based on the restored received signal, and generate first and second acknowledgement signals depending on whether the underground object exists or not.

2. The wearable apparatus of claim 1, further comprising a shielding unit configured to shield electromagnet waves transmitted to a user.

3. The wearable apparatus of claim 1, wherein the signal transmitter comprises:
a wireless transmission unit configured to generate the predetermined signal for detecting the underground object; and
a transmission detection sensor configured to transmit the signal transferred from the wireless transmission unit in the predetermined direction.

4. The wearable apparatus of claim 1, further comprising:
a command and display device configured to command the transmission of the predetermined signal for detecting the underground object and display the underground object information analyzed from the received signal to a user.

5. The wearable apparatus of claim 2, wherein the shielding unit is implemented between the wireless reception unit and the acknowledgement signal processing unit.

6. The wearable apparatus of claim 1, wherein the first acknowledgement signal is a target acknowledgement signal which is generated when the underground object exists.

7. The wearable apparatus of claim 1, wherein the second acknowledgement signal is a noise acknowledgement signal which is generated when the underground object does not exist.

8. The wearable apparatus of claim 1, wherein the predetermined signal comprises an electromagnetic wave and an ultrasonic wave.

9. A method for detecting an underground object, comprising:
transmitting a predetermined signal in a predetermined direction;
when a reflected wave corresponding to the transmitted signal is a predetermined reflected wave, analyzing the predetermined reflected wave; and
generating a first acknowledgement signal corresponding to the analyzed reflected wave, and informing a user of the first acknowledgement signal.

10. The method of claim 9, wherein when the predetermined reflected wave is not received, a second acknowledgement signal is generated.

11. The method of claim 9, wherein the predetermined reflected wave is a reflected wave which corresponds to the transmitted signal and is generated when the ground object exists.

12. The method of claim 9, wherein the first acknowledgement signal is an urgent acknowledgement signal which is generated when the underground object exists.

13. The method of claim 10, wherein the second acknowledgement signal is a normal acknowledgement signal which is generated when the underground object does not exist.

14. The method of claim 9, wherein the predetermined signal comprises an electromagnetic wave and an ultrasonic wave.
